(19) United States
(12) Patent Application Publication
(10) Pub. No.: US 2007/0048497 A1
(43) Pub. Date: Mar. 1, 2007

(54) Single-faced neck bonded laminates and methods of making same

(76) Inventors: Peiguang Zhou, Appleton, WI (US); Gregory K. Hall, Menasha, WI (US); Thomas Harold Roessler, Appleton, WI (US); Paul Theodore Van Gompel, Hortonville, WI (US)

Correspondence Address: KIMBERLY-CLARK WORLDWIDE, INC., 401 NORTH LAKE STREET, NEENAH, WI, 54956, US

(21) Appl. No.: 11/216,729

(22) Filed: Aug. 31, 2005

(51) Int. Cl. B32B 3/10

(52) U.S. Cl. 428/137; 428/138

(57) ABSTRACT

An elastic laminate capable of being rolled for storage and unwound from a roll when needed for use, includes an external elastic film layer including a core layer and a first skin layer, and a necked facing layer thermally bonded to the first skin layer. In one aspect, the first skin layer has a softening point between about 40° C. about 125° C. In another aspect, the film skin layers may include an elastic polyolefin-based polymer having a degree of crystallinity between about 3% and about 40%.

### BACKGROUND OF THE INVENTION

To “neck” or “necked” refers to a process of tensioning a fabric in a particular direction thereby reducing the width dimension of the fabric in the direction perpendicular to the direction of tension. For example, tensioning a nonwoven fabric in the MD causes the fabric to “neck” or narrow in the CD and give the necked fabric CD stretchability. Examples of such extensible and/or elastic fabrics include, but are not limited to, those described in U.S. Pat. No. 4,965,122 to Morman et al. and U.S. Pat. No. 5,336,545 to Morman et al. each of which is incorporated herein by reference in its entirety.

“Neck bonding” refers to the process wherein an elastic member is bonded to a non-elastic member while only the non-elastic member is extended or necked so as to reduce its dimension in the direction orthogonal to the extension. “Neck bonded laminate” refers to a composite elastic material made according to the neck bonding process, i.e., the layers are joined together when only the non-elastic layer is in an extended/necked condition. Such laminates usually have cross directional stretch properties. Further examples of neck-bonded laminates are such as those described in U.S. Pat. Nos. 5,226,992, 4,981,747 to Morman and U.S. Pat. No. 5,514,470 to Haffner et al., each of which is incorporated by reference herein in its entirety.

Such neck bonded laminates may include an elastic component that is a web, such as a meltblown web, a film, or a combination of such. The elastic layer is bonded in a stretched condition to two inelastic or extendable nonwoven facing materials, such that the resulting laminate is imparted with a textural feel that is pleasing on the hand. In particular, the elastic layer is bonded between the two facing layers, such that the facing layers sandwich the elastic layer.

The term “stretch bonded laminate” refers to a composite elastic material made according to a stretch bonding lamination process, i.e., elastic layer(s) are joined together with additional facing layers when the elastic layer is in an extended condition (such as by at least about 25 percent of its relaxed length) so that upon relaxation of the layers, the additional layer(s) is/are gathered. Such neck bonded laminates may include an elastic component that is a web, such as a meltblown web, a film, an array/series of generally parallel continuous filament strands (either extruded or pre-formed), or a combination of such. Such laminates usually have machine directional (MD) stretch properties and may be subsequently stretched to the extent that the additional (typically non-elastic) material gathered between the bond locations allows the elastic material to elongate. One type of stretch bonded laminate is disclosed, for example, by U.S. Pat. No. 4,720,415 to Vander Wielen et al., in which multiple layers of the same polymer produced from multiple banks of extruders are used. Other composite elastic materials are disclosed in U.S. Pat. No. 5,385,775 to Wright, copending U.S. Patent Publication No. 2002-0104608, published 8 Aug. 2002, and copending U.S. Patent Publication No. 2005-0148263, published 7 Jul. 2005, each of which is incorporated by reference herein in its entirety.

“Neck-stretch bonding” generally refers to a process wherein an elastic member is bonded to another member while the elastic member is extended (such as by about 25 percent of its relaxed length) and the other layer is a necked, non-elastic layer. “Neck-stretch bonded laminate” refers to a composite elastic material made according to the neck-stretch bonding process, i.e., the layers are joined together when both layers are in an extended condition and then allowed to relax. Such laminates usually have multi-directional stretch properties.

Such neck-stretch bonded laminates may be used to provide elasticity to various components of a personal care product and with the added benefit of a pleasant fabric-like touch, such as a diaper liner or outercover, diaper waist band material, diaper leg gasketing (cuff) material, diaper ear portions (that is, the point of attachment of a fastening system to a diaper), as well as side panel materials for diapers and child training pants. Since such materials often come in contact with skin of a human body, it is desirable that such materials be relatively soft to the touch, rather than rubbery in their feel (a sensation common for elastic materials). Such materials may likewise provide elasticity and comfort for materials that are incorporated into protective workwear, such as surgical gowns, face masks and drapes, labcoats, or protective outercovers, such as car, grill or boat covers.

While such soft and stretchy materials have assisted in making such elastic materials more user-friendly, there is still a need for such products that provide even more of a cloth-like fabric feel. In this regard, there is a need for such materials that provide even higher levels of stretch and retraction. There likewise remains a need for a laminate material that provides reduced stiffness. It is to such needs that the current invention is directed.

### SUMMARY OF THE INVENTION

An elastic single-faced neck bonded laminate capable of being rolled for storage, and unwound from a roll when needed for use, includes an external elastic layer that includes a film layer, and a facing layer bonded to only one side of the elastic layer. The film includes a core layer and at least one skin layer. In one embodiment, the core layer includes a styrene-isoprene-styrene block copolymer or a styrene-butadiene-styrene block copolymer. In one aspect, the film may have an ultimate elongation of between about 600 and about 800 percent. Desirably, the facing layer is extensible in a cross-direction of the material. As one example, the facing layer may be necked to obtain cross-direction extensibility.

The elastic laminate may include an elastic polyolefin-based polymer having a degree of crystallinity between about 3% and about 40%, or between about 5% and about 30%. The elastic polyolefin-based polymer may have a melt flow rate between about 10 and about 600 grams per 10 minutes, or between about 60 and about 300 grams per 10 minutes, or between about 150 and about 200 grams per 10 minutes; a melting/softening point between about 40 and about 160 degrees Celsius; and/or a density from about 0.8 to about 0.95, or about 0.85 to about 0.93, or about 0.86 to about 0.89 grams per cubic centimeter. The elastic polyolefin-based polymer may include polyethylene, polypropylene, butene, or octene homo- or copolymers, ethylene methacrylate, ethylene vinyl acetate, butyl acrylate copolymers, or a combination of any of these polymers. The elastic polyolefin-based polymer may be used to form the skin layers, the core layer, and/or the facing layer.

In another embodiment, the skin layer(s) of the elastic laminate may include a polymer selected from the group consisting of low density polyethylene, metallocene catalyzed polyethylene, polypropylene, polystyrene, ethylene-vinyl acetate, and polyolefin copolymers. In one aspect, the skin layers may have a basis weight between about 1% and about 10% of the core layer basis weight. In a further aspect, the skin layers may have a thickness between about 0.00002 and about 0.008 millimeters. In an even further aspect, the skin layer opposite the facing layer may include a diatomaceous earth. Desirably, the skin layer includes between about 5 and about 30 percent diatomaceous earth based on the weight of the skin layer. Advantageously, the diatomaceous earth helps prevent roll block when the laminate material is wound on a roll for storage.

In one embodiment, the facing material is thermally bonded to a skin layer of the elastic film. In one aspect, the facing material is thermally bonded to the skin layer with a bond pattern. Desirable bond patterns include cross-direction oriented continuous line patterns and cross-direction oriented intermittent line patterns. In one aspect, the bond pattern may have a bond area between about 5 and about 50 percent. In another aspect, the bond pattern may be an array of individual bond points, wherein the individual bond points have a surface area of greater than about 0.5 square millimeters.

In still another alternative embodiment of the invention, the elastic film layer has an overall basis weight up to about 80 gsm. In still another alternative embodiment of the invention, the elastic layer has a basis weight of between about 40 gsm and 70 gsm, or between about 45 gsm and 60 gsm.

In another embodiment, the elastic laminate material of the invention may have a first cycle extension tension value at 50% extension that is lower than the same test value obtained for the film used to make the elastic laminate material. In one aspect, the skin layer(s) may be stretch-thinned. In another aspect, the skin layer(s) may define apertures in a region adjacent thermal bond points bonding the facing layer to the skin layer.

In still another alternative embodiment of the invention, the facing layer has a basis weight of between about 0.3 and 1.5 osy. In yet another alternative embodiment of the invention, the facing layer is selected from the group consisting of nonwoven webs, nonwoven web laminates, foams, scrims, netting, and combinations thereof. In certain embodiments, the facing layer may include a spunbond-meltblown-spunbond laminate in which the meltblown layer includes an elastic polyolefin-based polymer and is positioned between two spunbond layers.

In an alternative embodiment, a method for forming a neck bonded laminate includes forming an elastic film layer by casting an elastic core layer positioned between first and second skin layers having a softening point less than 125 C; stretching the elastic film layer less than 20%; thermally bonding a necked facing layer to the stretched elastic film layer with thermal bond points while the stretched elastic film layer is in a stretched condition, to form a neck bonded laminate; and allowing such neck bonded laminate to retract. In one aspect, the skin layers may be stretch-thinned. In an additional aspect, the stretch-thinning may result in apertures defined in a region of the skin layer adjacent the thermal bond points. A single-faced neck bonded laminate (which term shall be used synonymously with single sided neck bonded laminate) made by the method, for use in a personal care or other stretchable article is also contemplated by the invention.

### BRIEF DESCRIPTION OF THE DRAWINGS

The invention will be better understood by reference to the following description of embodiments of the invention taken in conjunction with the accompanying drawings, wherein:

FIG. 1 illustrates a method of manufacturing a single sided neck bonded laminate in accordance with the invention.

FIG. 2 illustrates a cross sectional view of one embodiment of a single sided neck bonded laminate material.

FIG. 3a illustrates a top view of one embodiment of a single sided neck bonded laminate material.

FIG. 3b illustrates a top view of another embodiment of a single sided neck bonded laminate material.

FIG. 4 depicts a tensile cycle test curve for one embodiment of a single sided neck bonded laminate material.

FIG. 5 illustrates a personal care product utilizing a single sided stretch bonded laminate made in accordance with the invention.

FIG. 6 is a perspective view of boxer shorts in which a single sided neck bonded laminate material has been incorporated.

### DEFINITIONS

Within the context of this specification, each term or phrase below will include the following meaning or meanings.

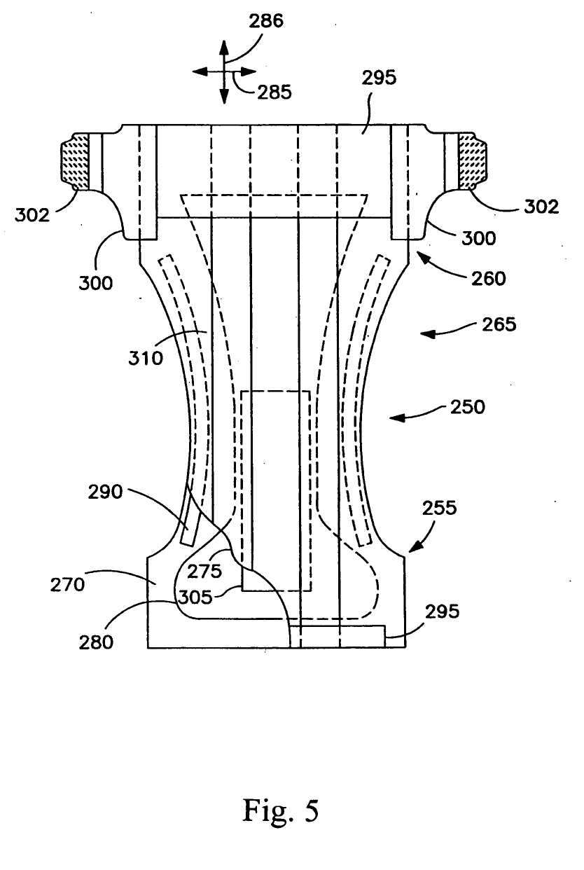

As used herein, the term “personal care product” means diapers, training pants, swimwear, absorbent underpants, adult incontinence products, and feminine hygiene products, such as feminine care pads, napkins and pantiliners. While a diaper is illustrated in FIG. 5, it should be recognized that the inventive material may just as easily be incorporated in any of the previously listed personal care products as an elastic component. For instance, such material may be utilized to make the elastic side panels of training pants.

As used herein the term “protective outerwear” means garments used for protection in the workplace, such as surgical gowns, hospital gowns, covergowns, labcoats, masks, and protective coveralls.

As used herein, the terms “protective cover” and “protective outercover” mean covers that are used to protect objects such as for example car, boat and barbeque grill covers, as well as agricultural fabrics.

As used herein, the terms “polymer” and “polymeric” when used without descriptive modifiers, generally include but are not limited to, homopolymers, copolymers, such as for example, block, graft, random and alternating copolymers, terpolymers, etc. and blends and modifications thereof. Furthermore, unless otherwise specifically limited, the term “polymer” includes all possible spatial configurations of the molecule. These configurations include, but are not limited to isotactic, syndiotactic and random symmetries.

As used herein, the terms “machine direction” or MD means the direction along the length of a fabric in the direction in which it is produced. The terms “cross machine direction,” “cross directional,” or CD mean the direction across the width of fabric, i.e. a direction generally perpendicular to the MD.

As used herein, the term “nonwoven web” means a polymeric web having a structure of individual fibers or threads which are interlaid, but not in an identifiable, repeating manner. Nonwoven webs have been, in the past, formed by a variety of processes such as, for example, meltblowing processes, spunbonding processes, hydroentangling, air-laid and bonded carded web processes.

As used herein, the term “bonded carded webs” refers to webs that are made from staple fibers which are usually purchased in bales. The bales are placed in a fiberizing unit/picker which separates the fibers. Next, the fibers are sent through a combining or carding unit which further breaks apart and aligns the staple fibers in the machine direction so as to form a machine direction-oriented fibrous nonwoven web. Once the web has been formed, it is then bonded by one or more of several bonding methods. One bonding method is powder bonding wherein a powdered adhesive is distributed throughout the web and then activated, usually by heating the web and adhesive with hot air. Another bonding method is pattern bonding wherein heated calender rolls or ultrasonic bonding equipment is used to bond the fibers together, usually in a localized bond pattern through the web and/or alternatively the web may be bonded across its entire surface if so desired. When using bicomponent staple fibers, through-air bonding equipment is, for many applications, especially advantageous.

As used herein the term “spunbond” refers to small diameter fibers which are formed by extruding molten thermoplastic material as filaments from a plurality of fine, usually circular capillaries of a spinneret with the diameter of the extruded filaments being rapidly reduced as by means shown, for example in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,542,615 to Dobo et al., each of which is incorporated by reference in its entirety herein.

As used herein, the term “meltblown” means fibers formed by extruding a molten thermoplastic material through a plurality of fine, usually circular die capillaries as molten threads or filaments into converging high velocity gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, in various patents and publications, including NRL Report 4364, “Manufacture of Super-Fine Organic Fibers” by B. A. Wendt, E. L. Boone and D. D. Fluharty; NRL Report 5265, “An Improved Device For The Formation of Super-Fine Thermoplastic Fibers” by K. D. Lawrence, R. T. Lukas, J. A. Young; and U.S. Pat. No. 3,849,241, issued Nov. 19, 1974, to Butin, et al. incorporated by reference herein in its entirety.

As used herein, the terms “sheet” and “sheet material” shall be interchangeable and in the absence of a word modifier, refer to woven materials, nonwoven webs, polymeric films, polymeric scrim-like materials, and polymeric foam sheeting.

The basis weight of nonwoven fabrics or films is usually expressed in ounces of material per square yard (osy) or grams per square meter (g/m² or gsm) and the fiber diameters are usually expressed in microns. (Note that to convert from osy to gsm, multiply osy by 33.91). Film thicknesses may also be expressed in microns or mil.

As used herein, the term “laminate” refers to a composite structure of two or more sheet material layers that have been adhered through a bonding step, such as through adhesive bonding, thermal bonding, point bonding, pressure bonding, extrusion coating or ultrasonic bonding.

As used herein, the term “elastomeric” shall be interchangeable with the term “elastic” and refers to sheet material which, upon application of a stretching force, is stretchable in at least one direction (such as the CD direction), and which upon release of the stretching force contracts/returns to approximately its original dimension. For example, a stretched material having a stretched length which is at least 50 percent greater than its relaxed unstretched length, and which will recover to within at least 50 percent of its stretched length upon release of the stretching force. A hypothetical example would be a one (1) inch sample of a material which is stretchable to at least 1.50 inches and which, upon release of the stretching force, will recover to a length of not more than 1.25 inches. Desirably, such elastomeric sheet contracts or recovers up to 50 percent of the stretch length in a particular direction, such as in either the machine direction or the cross machine direction. Even more desirably, such elastomeric sheet material recovers up to 80 percent of the stretch length in a particular direction, such as in either the machine direction or the cross machine direction. Even more desirably, such elastomeric sheet material recovers greater than 80 percent of the stretch length in a particular direction, such as in either the machine direction or the cross machine direction. Desirably, such elastomeric sheet is stretchable and recoverable in both the MD and CD directions.

As used herein, the term “semi-elastic” refers to sheet material that may be elastic or elastomeric, or that may be stretchable in at least one direction (such as the CD direction) and upon release of the stretching force at least partially retracts. For example, when a semi-elastic material is stretched to 200% its original dimension, upon release of the stretching force, the semi-elastic material will retract to less than 200% its original dimension, such as less than 175% its original dimension, or less than 150% its original dimension.

As used herein, the term “elastomer” shall refer to a polymer which is elastomeric.

As used herein, the term “thermoplastic” shall refer to a polymer which is capable of being melt processed.

As used herein, the term “inelastic” or “nonelastic” refers to any material which does not fall within the definition of “elastic” above.

As used herein, the term “multilayer laminate” means a laminate including a variety of different sheet materials. For instance, a multilayer laminate may include some layers of spunbond and some meltblown such as a spunbond/meltblown/spunbond (SMS) laminate and others as disclosed in U.S. Pat. No. 4,041,203 to Brock et al., U.S. Pat. No. 5,169,706 to Collier, et al., U.S. Pat. No. 5,145,727 to Potts et al., U.S. Pat. No. 5,178,931 to Perkins et al., and U.S. Pat. No. 5,188,885 to Timmons et al., each incorporated by reference herein in its entirety. Such a laminate may be made by sequentially depositing onto a moving forming belt first a spunbond fabric layer, then a meltblown fabric layer and last another spunbond layer and then bonding the laminate, such as by thermal point bonding. Alternatively, the fabric layers may be made individually, collected in rolls, and combined in a separate bonding step or steps. Multilayer laminates may also have various numbers of meltblown layers or multiple spunbond layers in many different configurations and may include other materials like films (F) or coform materials, e.g., SMS, SMMS, SM, SFS, and so forth.

As used herein, the term “coform” means a process in which at least one meltblown diehead is arranged near a chute through which other materials are added to the web while it is forming. Such other materials may be pulp, superabsorbent particles, cellulose or staple fibers, for example. Coform processes are shown in U.S. Pat. No. 4,818,464 to Lau and U.S. Pat. No. 4,100,324 to Anderson et al., each incorporated by reference herein in its entirety.

As used herein, the term “conjugate fibers” refers to fibers which have been formed from at least two polymers extruded from separate extruders but spun together to form one fiber. Conjugate fibers are also sometimes referred to as multicomponent or bicomponent fibers. The polymers are usually different from each other though conjugate fibers may be monocomponent fibers. The polymers are arranged in substantially constantly positioned distinct zones across the cross-section of the conjugate fibers and extend continuously along the length of the conjugate fibers. The configuration of such conjugate fiber may be, for example, a sheath/core arrangement wherein one polymer is surrounded by another or may be a side-by-side arrangement, a pie arrangement or an “islands-in-the-sea” arrangement. Conjugate fibers are taught in U.S. Pat. No. 5,108,820 to Kaneko et al., U.S. Pat. No. 4,795,668 to Krueger et al., and U.S. Pat. No. 5,336,552 to Strack et al. Conjugate fibers are also taught in U.S. Pat. No. 5,382,400 to Pike et al., and may be used to produce crimp in the fibers by using the differential rates of expansion and contraction of the two or more polymers. For two component fibers, the polymers may be present in varying desired ratios. The fibers may also have shapes such as those described in U.S. Pat. No. 5,277,976 to Hogle et al., U.S. Pat. No. 5,466,410 to Hills and U.S. Pat. Nos. 5,069,970 and 5,057,368 to Largman et al., which describe fibers with unconventional shapes. Each of the foregoing patents is incorporated by reference herein in its entirety.

As used herein the term “thermal point bonding” involves passing a fabric or web of fibers to be bonded between a calender roll and an anvil roll. The calender roll and anvil roll may impart heat to the fabric through the pressure generated between the calender roll and the anvil roll (pressure bonding). Alternatively and/or additionally, one or both of the calender roll and the anvil roll may be heated to further facilitate the thermal bonding of the fabric. The calender roll is usually, though not always, patterned in some way so that the entire fabric is not bonded across its entire surface, and the anvil roll is usually flat. As a result, various patterns for calender rolls have been developed for functional as well as aesthetic reasons. One example of a pattern has points and is the Hansen Pennings or “H&P” pattern with about a 30 percent bond area with about 200 bonds/square inch as taught in U.S. Pat. No. 3,855,046 to Hansen and Pennings, incorporated herein by reference in its entirety. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5 percent. Another typical point bonding pattern is the expanded Hansen Pennings or “EHP” bond pattern which produces a 15 percent bond area with a square pin having a side dimension of 0.037 inches (0.94 mm), a pin spacing of 0.097 inches (2.464 mm) and a depth of 0.039 inches (0.991 mm). Another typical point bonding pattern designated “714” has square pin bonding areas wherein each pin has a side dimension of 0.023 inches, a spacing of 0.062 inches (1.575 mm) between pins, and a depth of bonding of 0.033 inches (0.838 mm). The resulting pattern has a bonded area of about 15 percent. Yet another common pattern is the C-Star pattern which has a bond area of about 16.9 percent. The C-Star pattern has a cross-directional bar or “corduroy” design interrupted by shooting stars. Other common patterns include a diamond pattern with repeating and slightly offset diamonds with about a 16 percent bond area and a wire weave pattern looking as the name suggests, e.g. like a window screen pattern having a bond area in the range of from about 15 percent to about 21 percent and about 302 bonds per square inch. Another pattern includes continuous lines or intermittent lines made up of dash-like segments extending across the cross-direction of the fabric. When intermittent lines are used, the dash-like segments may be offset from one another in the machine direction. Further examples of continuous and intermittent line patterns are described below.

Typically, and unless otherwise specified herein, the percent bonding area varies from around 10 percent to around 30 percent of the area of the fabric laminate. As is well known in the art, the spot bonding holds the laminate layers together as well as imparts integrity to each individual layer by bonding filaments and/or fibers within each layer.

As used herein, the term “ultrasonic bonding” means a thermal bonding process performed, for example, by passing the fabric between a sonic horn and anvil roll as illustrated in U.S. Pat. No. 4,374,888 to Bornslaeger, incorporated by reference herein in its entirety.

As used herein, the term “adhesive bonding” means a bonding process which forms a bond by application of an adhesive. Such application of adhesive may be by various processes such as slot coating, spray coating and other topical applications. Further, such adhesive may be applied within a product component and then exposed to pressure such that contact of a second product component with the adhesive containing product component forms an adhesive bond between the two components.

As used herein, the term “post-calender treatment” refers to any treatment, such as the application of a nonblocking agent, which is typically applied to a laminate toward the end of the lamination process, such as following the passage of the laminate through a nip or over a calender roll, in order to reduce inter-layer peel strength.

As used herein, the term “inter-layer peel strength” refers to the peel strength required to separate a laminate from itself when unwound from a roll, as opposed to the peel strength between layers within the laminate. Inter-layer peel strength can be determined using the Roll Blocking Test Method described in detail below.

As used herein, and in the claims, the term “comprising” is inclusive or open-ended and does not exclude additional unrecited elements, compositional components, or method steps. Accordingly, such term is intended to be synonymous with the words “has”, “have”, “having”, “includes”, “including”, and any derivatives of these words.

As used herein, the terms “extendible” or “extensible” or “expandable” mean elongatable in at least one direction, but not necessarily recoverable.

Unless otherwise indicated, percentages of components in formulations are by weight.

### DETAILED DESCRIPTION OF THE INVENTION

For the purposes of this invention an elastic single-faced neck bonded laminate includes at least one elastic layer and one necked facing layer, the necked facing layer being applied to only one side of at least one elastic layer. The elastic layer suitably includes a film. The film suitably includes a core layer and at least one skin layer. Desirably, the core layer is elastic and the skin layers are extendible. Desirably, a first skin layer, to which at least one necked facing layer is thermally bonded, has a softening point between about 40° C. and about 125° C., more desirably between about 75° C. and about 125° C., and even more desirably between about 100° C. and about 125° C.

In one embodiment, one or both of the skin layers of the elastic laminate may include a polymer selected from the group consisting of low density polyethylene, metallocene catalyzed polyethylene, polypropylene, polystyrene, ethylene-vinyl acetate, and polyolefin copolymers.

The skin layers of the film suitably include an elastic polyolefin-based polymer. In addition to being useful in the skin layers, the elastic polyolefin-based polymer may be incorporated within the core layer, and/or the facing layer, as described in greater detail below. The elastic polyolefin based polymer desirably has a degree of crystallinity between about 3% and about 40%, or between about 5% and about 30%, or between about 15% and about 25%. The elastic polyolefin-based polymer may also have a melt flow rate between about 10 and about 600 grams per 10 minutes, or between about 60 and about 300 grams per 10 minutes, or between about 150 and about 200 grams per 10 minutes; a melting/softening point between about 40 and about 160 degrees Celsius; and/or a density from about 0.8 to about 0.95, or about 0.85 to about 0.93, or about 0.86 to about 0.89 grams per cubic centimeter. The elastic polyolefin-based polymer suitably may have a slow crystallization rate, with partial regions of crystalline and amorphous phases that make it inherently elastic and tacky. The elastic polyolefin-based polymer may include polyethylene, polypropylene, butene, or octene homo- or copolymers, ethylene methacrylate, ethylene vinyl acetate, butyl acrylate copolymers, or a combination of any of these polymers.

One example of a suitable elastic polyolefin-based polymer is VISTAMAXX, available from ExxonMobil Chemical of Baytown, Tex. Other examples of suitable polyolefin-based polymers include EXACT plastomer, OPTEMA ethylene methacrylate, and VISTANEX polyisobutylene, and metallocene-catalyzed polyethylene, all available from ExxonMobil Chemical, as well as AFFINITY polyolefin plastomers, such as AFFINITY EG8185 or AFFINITY GA 1950, available from Dow Chemical Company of Midland, Mich.; ELVAX ethylene vinyl acetate, available from E. I. Du Pont de Nemours and Company of Wilmington, Del.; and ESCORENE Ultra ethylene vinyl acetate, available from ExxonMobil.

At least one of the components of the elastic layer may be formed from an elastic polyolefin-based polymer having a degree of crystallinity between about 3% and about 40%, or between about 5% and about 30%, or between about 15% and about 25%, as described above. When the elastic polyolefin-based polymer is used to form the skin layer of the film, for example, the slow crystallization rate of the elastic polymer is advantageous because the skin layer is made semi-tacky by heating to adhesively bond the composite. After bonding, the elastic polyolefin-based polymer crystallizes and becomes non-tacky. Additionally, when the skin layer includes the elastic polymer, the skin layer may be applied at a higher add-on compared to non-elastic skin layers that would inhibit extension of the elastic film. More particularly, the elastic skin layer may be applied at an add-between about 1 percent and about 10 percent of the core layer basis weight. Inelastic skin layers may crack and form discrete islands if the film is stretched prior to lamination at higher add-on levels, which can lead to non-uniformity. However, elastic skin layers do not suffer such drawbacks at higher add-on levels. Furthermore, the higher add-on of elastic skin layers coupled with the slight tackiness of the elastic skin layers helps to better secure the film to the necked facing layer such that the film is less likely to come detached. Particularly, the peel strength of the layers within the laminate is greater than the peel strength of the exterior surfaces of the layers to one another when the laminate is unwound from a roll. For instance, the laminate may have an intra-layer peel strength of about 200 to about 450 grams per 3 inches cross-directional width at a strain rate of 300 mm/min, using the same test method as used for determining the inter-layer peel strength but instead pulling apart the elastic film layer from the necked facing layer.

Another benefit of using the elastic polyolefin-based polymer in the skin layers is the reduction or elimination of roll blocking, as demonstrated through the low inter-layer peel strength of the laminate. The non-tacky skin layers are advantageous when it is desirable to wind the neck bonded laminate on a roll for subsequent unwinding in a converting process. The non-tacky skin layers serve to prevent the material from sticking to itself on the roll. Other laminates may include post-calender treatment, such as non-elastic polypropylene meltblown dusting, to prevent roll blocking, but the incorporation of the elastic polymer in the skin layer may remove the need for any post-calender treatment. Incorporation of the elastic polymer in the skin layer without any post-calender treatment may result in an inter-layer peel strength of the laminate of between about 0 and about 70 grams per 3 inches cross-directional width at a strain rate of 300 mm/min, or between about 0 and about 60 grams per 3 inches cross-directional width at a strain rate of 300 mm/min, or between about 0 and about 50 grams per 3 inches cross-directional width at a strain rate of 300 mm/min. A shorter width of laminate may provide non-uniform results, but for the most part the inter-layer peel strength of the laminate has a linear relationship with respect to the width of the laminate. Thus, for example, a laminate having a width of 3 inches may exhibit inter-layer peel strength of about 60 grams per 3 inches cross-directional width at a strain rate of 300 mm/min, while the same laminate having a width of 1 inch may exhibit inter-layer peel strength of about 20 grams per inch cross-directional width at a strain rate of 300 mm/min.

In one embodiment, the skin layers may include, for example, between about 30% and about 100%, or between about 50% and about 90%, by weight elastic polyolefin-based polymer. As mentioned, the core layer of the film may also include an elastic polyolefin-based polymer. More particularly, the core layer may be composed of between about 5% and about 90%, or between about 5% and about 70%, by weight elastic polyolefin-based polymer.

The core layer and skin layers of the elastic film may include any elastic film forming polymer, resin, or blend thereof. For example, any or all of the layers within the film may include thermoplastic materials such as styrenic block copolymers having the general formula A-B-A′ where A and A′ are each a thermoplastic polymer endblock which contains a styrenic moiety such as a poly (vinyl arene) and where B is an elastomeric polymer midblock such as a conjugated diene or a lower alkene polymer.

Specific examples of useful styrenic block copolymers include hydrogenated polyisoprene polymers such as styrene-ethylenepropylene-styrene (SEPS), styrene-ethylenepropylene-styrene-ethylenepropylene (SEPSEP), hydrogenated polybutadiene polymers such as styrene-ethylenebutylene-styrene (SEBS), styrene-ethylenebutylene-styrene-ethylenebutylene (SEBSEB), styrene-butadiene-styrene (SBS), styrene-isoprene-styrene (SIS), and hydrogenated poly-isoprene/butadiene polymer such as styrene-ethylene-ethylenepropylene-styrene (SEEPS). Polymer block configurations such as diblock, triblock, multiblock, star and radial are also contemplated in this invention. In some instances, higher molecular weight block copolymers may be desirable. Block copolymers are available from Kraton Polymers U.S. LLC of Houston, Tex. under the designations KRATON G or D polymers, for example G1652, G1657, G1730, D1114, D1155, D1102, Septon Company of America, Pasadena, Tex. under the designations SEPTON 2004, SEPTON 4030, and SEPTON 4033, Dexco Polymers of Houston, Tex. under the designation VECTOR™ 4411. Another potential supplier of such polymers is Dynasol of Spain. Blends of such elastomeric resin materials are also contemplated as the primary component of the elastic film. Additionally, other desirable block copolymers are disclosed in U.S. Patent Publication 2003/0232928A1 which is incorporated by reference herein in its entirety.

Such base resins may be further combined with tackifiers and/or processing aids in compounds. Exemplary compounds include but are not limited to KRATON G2760, and KRATON G2755. Processing aids that may be added to the elastomeric polymer described above include a polyolefin to improve the processability of the composition. The polyolefin must be one which, when so blended and subjected to an appropriate combination of elevated pressure and elevated temperature conditions, is extrudable, in blended form, with the elastomeric base polymer. Useful blending polyolefin materials include, for example, polyethylene, polypropylene and polybutene, including ethylene copolymers, propylene copolymers and butene copolymers. A particularly useful polyethylene may be obtained from Eastman Chemical under the designation EPOLENE C-10. Two or more of the polyolefins may also be utilized. Extrudable blends of elastomeric polymers and polyolefins are disclosed in, for example, U.S. Pat. No 4,663,220, the content of which is hereby incorporated by reference in its entirety.

It may be desirable to have some tackiness/adhesiveness in the core layer or a skin layer to enhance bonding of the film to the facing layer. For example, the elastomeric polymer in the core layer or skin layer itself may be tacky when formed into the film or, alternatively, a compatible tackifying resin may be added to the extrudable elastomeric compositions described above to provide tackified elastomeric films for bonding to the necked facing. In regards to the tackifying resins and tackified extrudable elastomeric compositions, note the resins and compositions as disclosed in U.S. Pat. No. 4,787,699, hereby incorporated by reference in its entirety. In one embodiment, a single facing neck bonded laminate includes a tackifying resin included in a skin layer of an elastic film that is bonded to the single facing layer.

Any tackifier resin can be used which is compatible with the elastomeric polymer and can withstand the high processing (e.g. extrusion) temperatures. If the elastomeric polymer (e.g. A-B-A elastomeric block copolymer) is blended with processing aids such as, for example, polyolefins or extending oils, the tackifier resin should also be compatible with those processing aids. Generally, hydrogenated hydrocarbon resins are preferred tackifying resins, because of their better temperature stability. REGALREZ series tackifiers are examples of such hydrogenated hydrocarbon resins. REGALREZ hydrocarbon resins are available from Eastman Chemical. Of course, the present invention is not limited to use of such tackifying resins, and other tackifying resins which are compatible with the other components of the composition and can withstand the high processing temperatures, can also be used. Other tackifiers are available from ExxonMobil under the ESCOREZ designation.

Other exemplary elastomeric materials which may be used in the core layer or skin layers include polyurethane elastomeric materials such as, for example, those available under the trademark ESTANE from Noveon, polyamide elastomeric materials such as, for example, those available under the trademark PEBAX (polyether amide) from Ato Fina Company, and polyester elastomeric materials such as, for example, those available under the trade designation HYTREL from E.I. DuPont De Nemours & Company. Useful elastomeric polymers for the core layer or skin layers also include, for example, elastic polymers and copolymers of ethylene and at least one vinyl monomer such as, for example, vinyl acetates, unsaturated aliphatic monocarboxylic acids, and esters of such monocarboxylic acids. The elastic copolymers are disclosed in, for example, U.S. Pat. No. 4,803,117, incorporated by reference herein in its entirety.

In one embodiment, the blend used to form the core layer of the film includes for example, from about 40 to about 90 percent by weight elastomeric polymer base resin, from about 0 to about 40 percent polyolefin processing aid, and from about 0 to about 10 percent opacifying resin. These ratios can be varied depending on the specific properties desired and the polymers utilized. For an alternative embodiment, such blend includes between about 70 and 90 percent base resin, between about 5 to 15 percent processing aid, and between about 0 to about 5 percent opacifying resin.

In embodiments in which the skin layers do not include the elastic polyolefin-based polymer, a nonblocking agent may be applied to the film either as a nonblocking agent layer on a side opposite to that of the facing layer, or as a bonding agent (adhesive) between the film layer and the necked facing layer, or alternatively, as a bonding agent between the elastic layer and the necked facing layer and additionally over the bonded laminate, on a side opposite to that of the necked facing layer.

As described above, the elastic layer suitably includes a film. In one embodiment, the film may be an apertured film. In other embodiments, additional components may be included in the elastic layer, such as an array of continuous filament strands, an elastic scrim or netting structure, a foam material, or a combination of any of the foregoing materials.

The elastic layer is bonded to a facing layer. Desirably, the facing layer is extensible in one or more directions. While it is desirable that the facing layer be a nonwoven layer, such facing layer may also be a woven web, any other neckable material, or a combination of such. The facing layer may suitably be a nonwoven material such as, for example, one or more spunbonded webs (such as a conjugate fiber spunbond web), meltblown webs, or bonded carded webs. An example of a spunbond web may be a polypropylene spunbond web having a basis weight of between about 0.3 and 0.8 osy. In a further alternative embodiment, the spunbond web is necked between about 25 and 60 percent before it is bonded to the elastic layer. In still a further embodiment of the invention, the facing layer is a multilayer material having, for example, at least one layer of spunbond web joined to at least one layer of meltblown web, bonded carded web, or other suitable material. The facing layer may also be a composite material made of a mixture of two or more different fibers or a mixture of fibers and particulates, such as a coform material. Such mixtures may be formed by adding fibers and/or particulates to the gas stream in which meltblown fibers are carried so that an intimate entangled comingling of meltblown fibers and other materials, i.e. woodpulp, staplefibers and particulates such as, for example, hydrocolloid (hydrogel), particulates commonly referred to as superabsorbent materials, occurs prior to collection of the meltblown fibers upon a collecting device to form a coherent web of randomly dispersed meltblown fibers and other materials such as disclosed in U.S. Pat. No. 4,100,324, the disclosure of which is hereby incorporated by reference in its entirety. The facing layer may either be unwound from a roll or formed in-line.

Such necked material may also be pretreated in some fashion prior to being bonded to the elastic layer. Such pretreatments include for instance being necked. Such pretreatment may offer additional properties to the overall laminate material, such as bi or multidirectional stretch capabilities. Such necked layer may itself include multiple layers, and as such be a multilayered laminate.

As mentioned, the facing layer may also include an elastic polyolefin-based polymer, as described above. More particularly, the facing layer may be composed of between about 0% and about 100%, or between about 60% and about 100%, by weight elastic polyolefin-based polymer. In certain embodiments, for example, the necked facing layer may be a spunbond-meltblown-spunbond laminate in which the meltblown layer includes, in whole or in part, the elastic polyolefin-based polymer. Alternatively, the facing layer may be spunbond, meltblown, hydroentangled, or other type of nonwoven material including the elastic polyolefin-based polymer. In certain embodiments, for example, both the facing layer and the elastic film layer may include an elastic polyolefin-based polymer, as described above.

The single sided neck bonded laminate material is desirably laminated using a thermal bonding process. In one embodiment, the laminate material is laminated using a thermal point bonding process. In particular, the material may be made by either extruding or unwinding an elastic film and thermally bonding the film to a necked facing layer. An adhesive may be used between the facing and the film, but adhesives may increase the stiffness of the laminate. Desirably, no adhesives are used to laminate the film and the necked facing, thus making an adhesive-free laminate.

It is desirable that such single-sided neck bonded laminate material demonstrate a cross-direction stretch to stop value, as described below, of between about 15 and about 250 percent, more desirably between about 25 and about 150 percent. In an alternative embodiment, such material demonstrates a stretch to stop value of between about 50 and 200 percent. In still a further alternative embodiment, such single-sided neck bonded laminate material demonstrates a stretch to stop value of between about 80 and 150 percent.

In one embodiment, a method for producing a single sided facing neck bonded elastic laminate material utilizes a facing such as that which has been previously described, and an elastic film having an elastic core layer and first and second skin layers that is thermally bonded to the facing, such that the laminate has a structure of ABCD, in which the “A” represents the single side necked facing, the “B” represents the first skin layer, the “C” represents the elastic core layer, and the “D” represents the exposed second skin layer. In such a fashion the resulting material demonstrates increased stretch levels, and the ability of the material to be rolled for storage over itself if it is not to be used immediately. The material likewise demonstrates enhanced flexibility and drapeability since the neck bonded laminate is not constrained by a second and opposing facing layer.

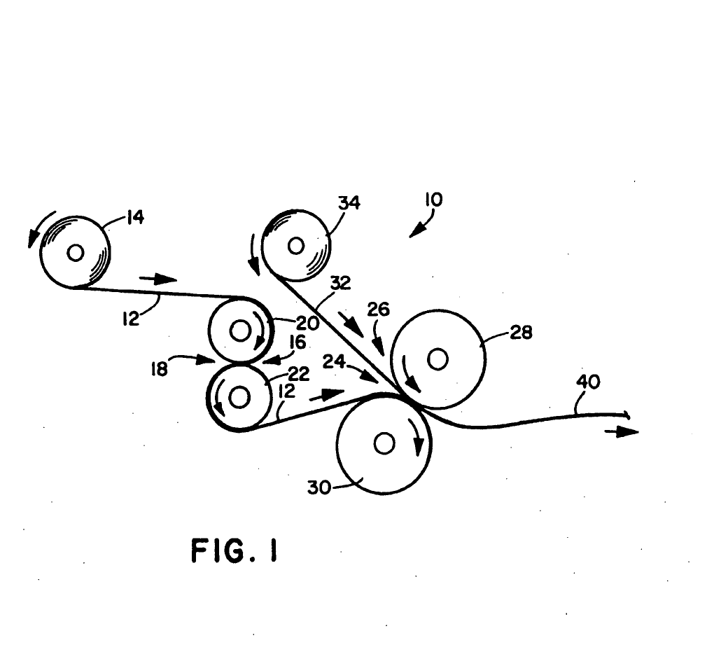

As can be seen in FIG. 1, which illustrates a schematic view of a method for manufacturing a single sided neck bonded laminate material in accordance with the invention, FIG. 1 illustrates a single faced neck bonded laminate manufacturing process 10. A neckable material 12 as described above is unwound from a supply roll 14 and travels in the direction indicated by the arrow associated therewith as the supply roll 14 rotates in the direction of the arrows associated therewith. The neckable material 12 passes through a nip 16 of the drive roller arrangement 18 formed by the driver rollers 20 and 22. The neckable material 12 may be formed by known nonwoven extrusion processes, such as, for example, known meltblowing process or known spunbonding processes, and passed directly through the nip 16 without first being stored on a supply roll.

An elastic film 32 including an elastic core layer and first and second skin layers as described above is unwound from a supply roll 34 and travels in the direction indicated by the arrow associated therewith as the supply roll 34 rotates in the direction of the arrows associated therewith. The elastic film 32 passes through the nip 24 of the bonder roller arrangement 26 formed by the bonder rollers 28 and 30. The elastic film 32 may be formed by known film extrusion processes, such as cast or blown film extrusion processes, and passed directly through the nip 24 without first being stored on a supply roll.

The neckable material 12 passes through the nip 16 of the S-roll arrangement 18 in a reverse-S path as indicated by the rotation direction arrows associated with the stack rollers 20 and 22. From the S-roll arrangement 18, the neckable material 12 passes through the pressure nip 24 formed by a bonder roller arrangement 26. Because the peripheral linear speed of the rollers of the S-roll arrangement 18 is controlled to be less than the peripheral linear speed of the rollers of the bonder roller arrangement 26, the neckable material 12 is tensioned between the S-roll arrangement 18 and the pressure nip of the bonder roll arrangement 26. By adjusting the difference in the speeds of the rollers, the neckable material 12 is tensioned so that it necks a desired amount and is maintained in such tensioned necked condition while the elastic film 32 is joined to the necked material 12 during their passage through the bonder roller arrangement 26 to form a single faced neck bonded laminate 40. Other methods (not shown) of tensioning the neckable material 12 may be used such as, for example, tenter frames or other cross-machine direction stretcher arrangements that expand the neckable material 12 in other directions such as, for example, the cross-machine direction so that, after bonding to the elastic sheet 32, the resulting composite elastic necked-bonded material 40 will be elastic in a direction generally parallel to the direction of necking, i.e., in the machine direction.

The elastic film 32 may be stretched by the differential speed of the bonder roll arrangement 26 to elongate, thin, and tension the film. The bonder roll arrangement 26 is therefore operating at speeds which exceed the speed at which the elastic film 32 is unwound from the supply roll 34. In one embodiment, the elastic film 32 is stretched between about 1 and about 40 percent from the supply roll to the bonder roller arrangement 26. Desirably, the elastic film 32 is stretched between about 15 and about 25 percent from the supply roll to the bonder roller arrangement. When the elastic film is bonded to the necked facing layer while the film is in a tensioned stretched state, the film subsequently retracts, causing the necked facing layer to gather between points on its surface that are bonded to the elastic film layer. Essentially, those areas that are gathered are not bonded to the film layer.

The bonder roller arrangement 26 includes a pattern roller 28, such as, for example, a pin embossing roller, and a smooth anvil roller 30. One or both of the patterned roller 28 and the smooth roller 30 may be heated and the pressure between these two rollers may be adjusted by well-known means to provide the desired temperature, if any, and bonding pressure to join the necked material 12 to the elastic film 32 forming a composite elastic neck bonded material 40. The necked material 12 and the elastic film 32 are desirably bonded using a pattern of lines extending substantially in the cross direction (CD) of the fabric. The CD-oriented line pattern may include CD lines that extend uninterrupted across the entire cross direction of the material, or may include shorter segments. In one embodiment, the lines are from about 0.5 to 3 millimeters wide, extend across the entire cross direction of the material, and are spaced from about 1 to about 10 millimeters apart in the machine direction. In another embodiment, the lines are broken into segments between about 2 to about 10 millimeters long in the CD, are from about 0.5 to 3 millimeters wide, and are separated by a 2 to 10 millimeter spacing between the segments across the cross direction. In the machine direction, the segments are staggered with respect to the adjacent row and are spaced from the adjacent row by between about 1 and about 10 millimeters. In an alternate embodiment, ultrasonic welding may be used to bond the necked material 12 to the elastic film 32 to form a composite elastic neck bonded material 40.

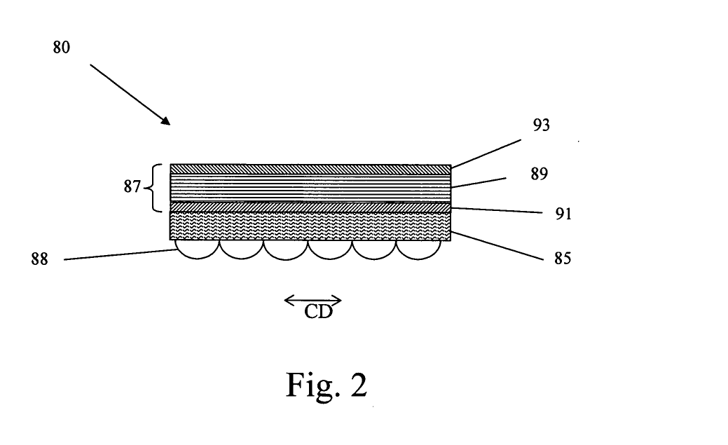

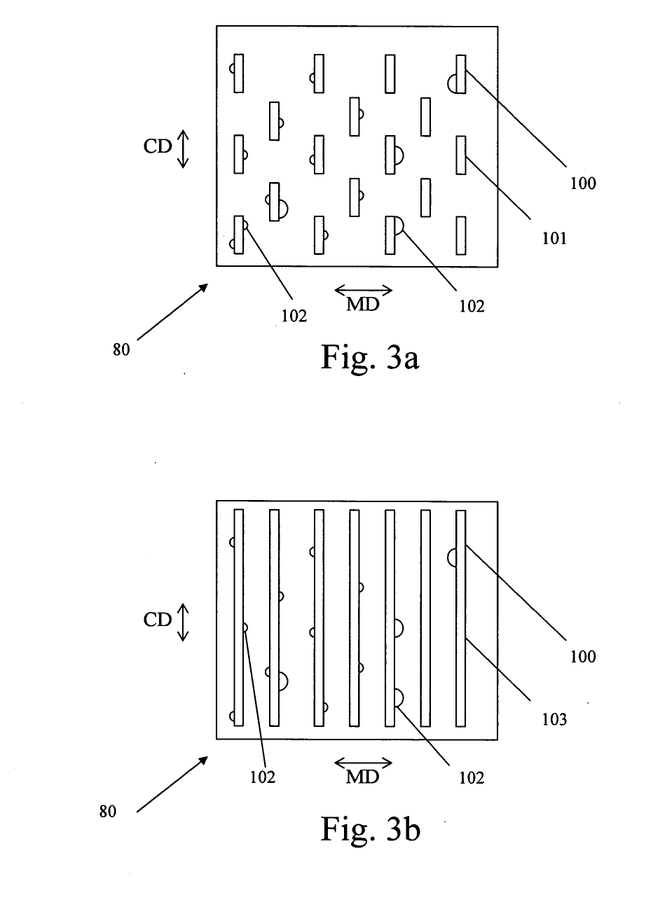

Such laminate structure can be seen in FIG. 2 which illustrates a cross sectional stylistic view of a necked bonded laminate 80 made in accordance with the invention. As can be seen in the figure, the facing 85 may be situated under/immediately adjacent the elastic film 87. The elastic film 87 includes an elastic core layer 89 positioned between first and second skin layers 91, 93. The facing 85 may be situated under/immediately adjacent the first skin layer 91. When the facing 85 is necked, the facing includes gathers 88 that provide extensibility in the cross-direction of the material. As illustrated in the stylistic plan view shown in FIG. 3a, a laminate 80 made in accordance with the invention may include bond points 100 at which the elastic film 87 and necked facing layer 85 are bonded together. In one embodiment, the bond points 100 are shaped as intermittent lines 101 arranged parallel to the cross direction of the laminate 80 as described above. Stretch thinning of the skin layers 91, 93 may result in the formation of a plurality of apertures 102 in the skin layers 91, 93 adjacent the bond points 100. Alternatively, as illustrated in the stylistic plan view of FIG. 3b, a laminate 80 made in accordance with the invention may include bond points 100 at which the elastic film 87 and necked facing layer 85 are bonded together. In one embodiment, the bond points 100 are shaped as continuous lines 103 and arranged parallel to the cross direction of the laminate 80 as described above. As described above, stretch thinning of the skin layers 91, 93 may result in the formation of a plurality of apertures 102 in the skin layers 91, 93 adjacent the bond points 100. The apertures 102 may be of any size up to the size of the bond points. For example, the apertures 102 may be from 0.1 to 2.0 millimeters across. In another example, the apertures may be from 0.25 to about 1 millimeter across. Surprisingly, in one embodiment, the neck bonded laminates exhibit a lower initial modulus (as indicated by the initial slope of the tension curve) and lower tensions at equivalent extension lengths than the film used to make the laminate. For example, the film by itself may have a higher first cycle extension tension at 50% extension than does the film laminated to a facing material according to the present invention. As another example, the film by itself may have a higher first cycle retraction tension at 50% extension than does the film laminated to a facing material according to the present invention. Without wishing to be bound by a particular theory, it is believed that lower tensions are achieved due to stretch thinning of the skin layers that occurs during the lamination process. Additionally, the creation of apertures adjacent the thermal bond points may contribute to the reduction in tension and modulus. Thus a low tension, highly elastic neck stretched laminate can be made.

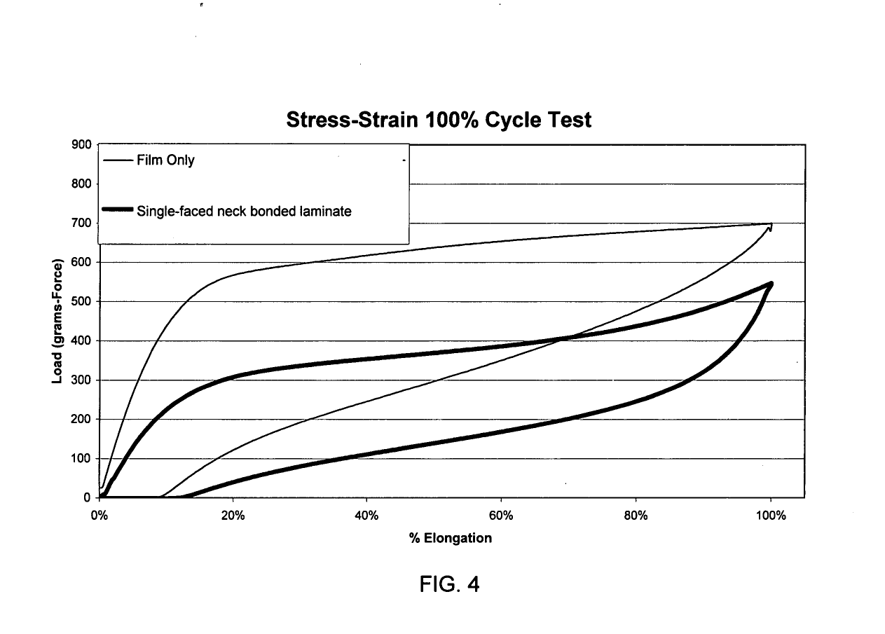

To demonstrate the principles of the present invention, an elastic film having two skin layers and a core layer therebetween was prepared using a conventional cast film process. The core layer was prepared from a dry blend of 60% styrene-isoprene-styrene block copolymer (available as KRATON D1164 from KRATON Polymers, LLC), 25% styrene-isoprene-styrene block copolymer (available as VECTOR 4411 from Dexco Polymers), 10% ethylene vinyl acetate (available as ELVAX 240 from DuPont), and 5% titanium dioxide concentrate (50% titanium dioxide in 50% polyethylene) (available as SCC-11692 from Standridge Color Corporation of Social Circle, Ga.). The skin layers were 4 weight percent on each side of the core layer and included 20 weight percent diatomaceous earth (available as Celite DE form Celite Corporation of Santa Barbara, Calif.) and 80 weight percent polyolefin plastomer (available as AFFINITY 1450 from Dow Chemical Company of Midland, Mich.). At basis weights of about 50 to about 80 gsm, the opaque film exhibited 250-400 gram tension at 100% elongation. The ultimate elongation of the films was about 600 to about 800 percent. The film was able to rewound on a roll and unwound without any blocking of the film on the roll. A polypropylene spunbond material having a basis weight of 0.5 osy was necked by about 50 to about 60% for use as a necked facing material. The film was unwound and stretched about 15% before being thermally laminated with necked facings between a smooth steel roll and a patterned steel roll at a bonding speed of 9 to 18 feet per minute at a bonding temperature of 130 C and a nip pressure of about 75 psi to form a single faced neck bonded laminate. The bond pattern used was a pattern of continuous lines oriented in the cross-direction of the material. The lines were 2 millimeter wide and were separated by 5 millimeter in the machine direction. The neck bonded laminate exhibited a stretch to stop of 88 to 145% in the cross direction. FIG. 4 shows a graph comparing a 100% extension cycle test for both the film alone and the neck bonded laminate. Surprisingly, the neck bonded laminate exhibits a lower initial modulus (as indicated by the initial slope of the tension curve) and lower tensions at equivalent extension lengths than the film used to make the laminate. For example, the film by itself has a higher first cycle extension tension at 50% extension than does the film laminated to the facing material according to the present invention. As another example, the film by itself has a higher first cycle retraction tension at 50% extension than does the film laminated to a facing material according to the present invention. Without wishing to be bound by a particular theory, it is believed that lower tensions are achieved due to stretch thinning of the skin layers that occurs during the lamination process. Thus a low tension, highly elastic neck stretched laminate is made.

Such single sided facing neck bonded laminate materials have particular effectiveness for use in personal care products to provide elastic attributes to such products. Such single sided facing neck bonded laminate materials can provide higher extensibility in either the CD direction than a laminate with facings applied to two opposing surfaces of an elastic film layer, and can also provide a corrugated appearance and a softer feel.

Such material may be useful in providing elastic waist, leg cuff/gasketing, stretchable ear, side panel or stretchable outer cover applications. While not intending to be limiting, FIG. 5 is presented to illustrate the various components of a personal care product, such as a diaper, that may take advantage of such elastic materials. Other examples of personal care products that may incorporate such materials are training pants (such as in side panel materials) and feminine care products. By way of illustration only, training pants suitable for use with the present invention and various materials and methods for constructing the training pants are disclosed in PCT Patent Application WO 00/37009 published Jun. 29, 2000 by A. Fletcher et al; U.S. Pat. No. 4,940,464 issued Jul. 10, 1990 to Van Gompel et al.; U.S. Pat. No. 5,766,389 issued Jun. 16, 1998 to Brandon et al.; and U.S. Pat. No. 6,645,190 issued Nov. 11, 2003 to Olson et al., which are each incorporated herein by reference in its entirety.

With reference to FIG. 5, the disposable diaper 250 generally defines a front waist section 255, a rear waist section 260, and an intermediate section 265 which interconnects the front and rear waist sections. The front and rear waist sections 255 and 260 include the general portions of the diaper which are constructed to extend substantially over the wearer's front and rear abdominal regions, respectively, during use. The intermediate section 265 of the diaper includes the general portion of the diaper that is constructed to extend through the wearer's crotch region between the legs. Thus, the intermediate section 265 is an area where repeated liquid surges typically occur in the diaper.

The diaper 250 includes, without limitation, an outer cover, or backsheet 270, a liquid permeable bodyside liner, or topsheet, 275 positioned in facing relation with the backsheet 270, and an absorbent core body, or liquid retention structure, 280, such as an absorbent pad, which is located between the backsheet 270 and the topsheet 275. The backsheet 270 defines a length, or longitudinal direction 286, and a width, or lateral direction 285 which, in the illustrated embodiment, coincide with the length and width of the diaper 250. The liquid retention structure 280 generally has a length and width that are less than the length and width of the backsheet 270, respectively. Thus, marginal portions of the diaper 250, such as marginal sections of the backsheet 270 may extend past the terminal edges of the liquid retention structure 280. In the illustrated embodiments, for example, the backsheet 270 extends outwardly beyond the terminal marginal edges of the liquid retention structure 280 to form side margins and end margins of the diaper 250. The topsheet 275 is generally coextensive with the backsheet 270 but may optionally cover an area which is larger or smaller than the area of the backsheet 270, as desired.

To provide improved fit and to help reduce leakage of body exudates from the diaper 250, the diaper side margins and end margins may be elasticized with suitable elastic members, as further explained below. For example, as representatively illustrated in FIG. 5, the diaper 250 may include leg elastics 290 which are constructed to operably tension the side margins of the diaper 250 to provide elasticized leg bands which can closely fit around the legs of the wearer to reduce leakage and provide improved comfort and appearance. Waist elastics 295 are employed to elasticize the end margins of the diaper 250 to provide elasticized waistbands. The waist elastics 295 are configured to provide a resilient, comfortably close fit around the waist of the wearer.

The single sided neck bonded laminates of the inventive structure and methods are suitable for use as the leg elastics 290 and waist elastics 295. Exemplary of such materials are laminate sheets which either include or are adhered to the backsheet, such that elastic constrictive forces are imparted to the backsheet 270.

As is known, fastening means, such as hook and loop fasteners, may be employed to secure the diaper 250 on a wearer. Alternatively, other fastening means, such as buttons, pins, snaps, adhesive tape fasteners, cohesives, fabric-and-loop fasteners, or the like, may be employed. In the illustrated embodiment, the diaper 250 includes a pair of side panels 300 (or ears) to which the fasteners 302, indicated as the hook portion of a hook and loop fastener, are attached. Generally, the side panels 300 are attached to the side edges of the diaper in one of the waist sections 255, 260 and extend laterally outward therefrom. The side panels 300 may be elasticized or otherwise rendered elastomeric by use of a single sided stretch bonded laminate made from the inventive structure. Examples of absorbent articles that include elasticized side panels and selectively configured fastener tabs are described in PCT Patent Application No. WO 95/16425 to Roessler; U.S. Pat. No. 5,399,219 to Roessler et al.; U.S. Pat. No. 5,540,796 to Fries; and U.S. Pat. No. 5,595,618 to Fries each of which is hereby incorporated by reference in its entirety.

The diaper 250 may also include a surge management layer 305, located between the topsheet 275 and the liquid retention structure 280, to rapidly accept fluid exudates and distribute the fluid exudates to the liquid retention structure 280 within the diaper 250. The diaper 250 may further include a ventilation layer (not illustrated), also called a spacer, or spacer layer, located between the liquid retention structure 280 and the backsheet 270 to insulate the backsheet 270 from the liquid retention structure 280 to reduce the dampness of the garment at the exterior surface of a breathable outer cover, or backsheet, 270. Examples of suitable surge management layers 305 are described in U.S. Pat. No. 5,486,166 to Bishop and U.S. Pat. No. 5,490,846 to Ellis.

As representatively illustrated in FIG. 5, the disposable diaper 250 may also include a pair of containment flaps 310 which are configured to provide a barrier to the lateral flow of body exudates. The containment flaps 310 may be located along the laterally opposed side edges of the diaper adjacent the side edges of the liquid retention structure 280. Each containment flap 310 typically defines an unattached edge which is configured to maintain an upright, perpendicular configuration in at least the intermediate section 265 of the diaper 250 to form a seal against the wearer's body. The containment flaps 310 may extend longitudinally along the entire length of the liquid retention structure 280 or may only extend partially along the length of the liquid retention structure. When the containment flaps 310 are shorter in length than the liquid retention structure 280, the containment flaps 310 can be selectively positioned anywhere along the side edges of the diaper 250 in the intermediate section 265. Such containment flaps 310 are generally well known to those skilled in the art. For example, suitable constructions and arrangements for containment flaps 310 are described in U.S. Pat. No. 4,704,116 to K. Enloe.

The diaper 250 may be of various suitable shapes. For example, the diaper may have an overall rectangular shape, T-shape or an approximately hour-glass shape. In the shown embodiment, the diaper 250 has a generally I-shape. Other suitable components which may be incorporated on absorbent articles of the present invention may include waist flaps and the like which are generally known to those skilled in the art. Examples of diaper configurations suitable for use in connection with the instant invention which may include other components suitable for use on diapers are described in U.S. Patent No.4,798,603 to Meyer et al.; U.S. Pat. No. 5,176,668 to Bernardin; U.S. Pat. No. 5,176,672 to Bruemmer et al.; U.S. Pat. No. 5,192,606 to Proxmire et al. and U.S. Pat. No. 5,509,915 to Hanson et al. each of which is hereby incorporated by reference in its entirety.

The various components of the diaper 250 are assembled together employing various types of suitable attachment means, such as adhesive bonding, ultrasonic bonding, thermal point bonding or combinations thereof. In the shown embodiment, for example, the topsheet 275 and backsheet 270 may be assembled to each other and to the liquid retention structure 280 with lines of adhesive, such as a hot melt, pressure-sensitive adhesive. Similarly, other diaper components, such as the elastic members 290 and 295, fastening members 302, and surge layer 305 may be assembled into the article by employing the above-identified attachment mechanisms.

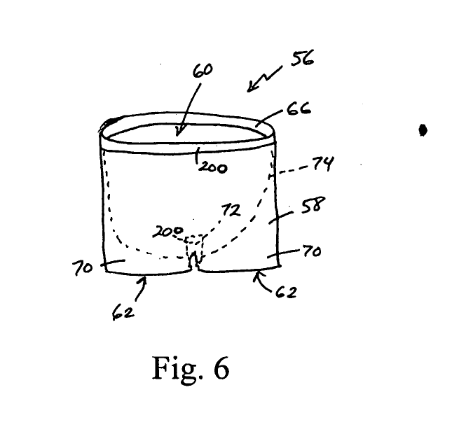

Referring to FIG. 6, the illustrated personal care garment includes a chassis 58 defining a waist opening 60 and two opposing leg openings 62. Side panels 64 may be refastenable or non-refastenable. It will be appreciated that any number of side panel configurations may be used in the context of the invention. The single-faced neck bonded laminate materials 200 may be used to form the side panels 64 in part or in their entirety. A waistband region 66 is configured to encircle the waist of the wearer when worn; however, the full circumference of the waistband 66 may or may not be elasticized. Thus, the single-faced neck bonded laminate material 200 may be used in the full circumference of the waistband 66 or merely a portion of the waistband 66. Similarly, the single-faced neck bonded laminate materials 200 may be used in the full circumference of the leg openings 62 or around merely a portion of the leg openings 62 to form a leg gasket 68. Leg gasket components may include leg elastics, leg cuffs, containment flaps, and/or any additional components.

The chassis 58 of the boxer shorts 56 includes hanging legs 70. The chassis 58 of the boxer shorts 56 further includes a contracted crotch region 72. The contracted crotch region 72 may be positioned approximately transversely midway between the leg openings 62 and aligned with a longitudinal centerline of the chassis 58. The single-faced neck bonded laminate materials 200 can be used to form the contracted crotch region 72. In particular embodiments, an absorbent structure 74 may be attached to the chassis 58. The single-faced neck bonded laminate materials 30 may be used, in whole or in part, in the formation of various portions of the absorbent structure 74, such as the waistband 66, the side panels 64, and/or the leg gaskets 68. More detailed descriptions and additional embodiments of boxer shorts 56 in which the single-faced neck bonded laminate materials 200 may be applicable are provided in U.S. Patent Publication No. 2004/0098791, incorporated herein by reference in its entirety in a manner consistent with the invention.

It should be appreciated that such single side facing neck bonded laminate materials may likewise be used in other personal care products, protective outerwear, protective coverings and the like. Further such materials can be used in bandage materials for both human and animal bandaging products. Use of such materials provides acceptable elastic performance at a lower manufacturing cost.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged either in whole or in part. Furthermore, those of ordinary skill in the art will appreciate that the foregoing description is by way of example only, and is not intended to limit the invention so further described in such appended claims. Further, it is recognized that many embodiments may be conceived that do not achieve all of the advantages of some embodiments, yet the absence of a particular advantage shall not be construed to necessarily mean that such an embodiment is outside the scope of the present invention. In addition, it should be noted that any given range presented herein is intended to include any and all lesser included ranges. For example, a range of from 45-90 would also include 50-90; 45-80; 46-89 and the like. Thus, the range of 95% to 99.999% also includes, for example, the ranges of 96% to 99.1%, 96.3% to 99.7%, and 99.91% to 99.999%, etc.

### Test Method Procedures

### Stretch-to-Stop Test

“Stretch-to-stop” refers to a ratio determined from the difference between the unextended dimension of a stretchable laminate and the maximum extended dimension of a stretchable laminate upon the application of a specified tensioning force and dividing that difference by the unextended dimension of the stretchable laminate. If the stretch-to-stop is expressed in percent, this ratio is multiplied by 100. For example, a stretchable laminate having an unextended length of 5 inches (12.7 cm) and a maximum extended length of 10 inches (25.4 cm) upon applying a force of 750 grams has a stretch-to-stop (at 750 grams) of 100 percent. Stretch-to-stop may also be referred to as “maximum non-destructive elongation.” Unless specified otherwise, stretch-to-stop values are reported herein at a load of 750 grams. In the elongation or stretch-to-stop test, a 3-inch by 7-inch (7.62 cm by 17.78 cm) sample, with the larger dimension being the machine direction, the cross direction, or any direction in between, is placed in the jaws of a Sintech machine using a gap of 5 cm between the jaws. The sample is then pulled to a stop load of 750 gms with a crosshead speed of about 20 inches/minute (50.8 cm/minute). For the stretchable laminate material of this invention, it is desirable that it demonstrate a stretch to stop value between about 15-200 percent, alternatively between about 25 and 150 percent, still in a further alternative, between about 80-250 percent. The stretch to stop test is done in the direction of extensibility (stretch). Depending upon the material being tested, a greater applied force may be more appropriate. For example, for a single faced laminate the applied force of 750 grams per 3 inch cross-directional width is typically appropriate; however, for certain laminates, particularly higher basis weight laminates, an applied force between 750 and 2000 grams per 3 inch cross-directional width may be most appropriate.

### Load-Elongation Cycle Test

A rectangular sample (3 inch wide×6 inch long) is placed in the clamps of a constant rate of extension (CRE) load frame. One example load frame is a SINTECH tensile tester which is available from the MTS Systems Corporation, Eden Prairie, Minn. (model Synergie 200).

A four inch gauge length is situated between the sample grips and the sample is elongated at 500 mm/min. to 100% elongation (i.e., 8 in. between the sample grips). The cross-head is then returned to the original 4 inch gauge length position to complete the cycle. If desired, subsequent cycles to 100% elongation may be performed, or the sample may be then elongated a third time until the sample breaks at the ultimate elongation.

Data points are recorded and plotted in grams force on the Y axis and % elongation on the X axis (data acquired at a rate of 100 data points per cycle). The percent set is determined as the percent elongation at which the specimen reaches zero load on the return portion (i.e. retraction) of the cycle. Testing is conducted at approximately 73° F. and about 50 percent relative humidity.

What is claimed is:

1. An elastic single-faced neck bonded laminate comprising:
an external elastic layer comprising a film, the film comprising a core layer and a first skin layer, the first skin layer having a softening point between about 40° C. about 125° C.; and
a necked facing layer thermally bonded to the first skin layer.

2. The elastic laminate of claim 1, wherein the core layer comprises a styrene-isoprene-styrene block copolymer or a styrene-butadiene-styrene block copolymer.

3. The elastic laminate of claim 1, wherein the core layer comprises an opacifier.

4. The elastic laminate of claim 1, wherein the core layer comprises an elastic polyolefin-based polymer having a degree of crystallinity between about 3% and about 40%.

5. The elastic laminate of claim 4, wherein the elastic polyolefin-based polymer has a melt flow rate between about 10 and about 600 grams per 10 minutes.

6. The elastic laminate of claim 4, wherein the elastic polyolefin-based polymer has a density from about 0.8 to about 0.95 grams per cubic centimeter.

7. The elastic laminate of claim 4, wherein the elastic polyolefin-based polymer comprises at least one of the group consisting of polyethylene, polypropylene, butene, or octene homo- or copolymers, ethylene methacrylate, ethylene vinyl acetate, and butyl acrylate copolymers.

8. The elastic laminate of claim 1, wherein the skin layer comprises a polymer selected from the group consisting of low density polyethylene, metallocene catalyzed polyethylene, polypropylene, polystyrene, ethylene-vinyl acetate, and polyolefin copolymers.

9. The elastic laminate of claim 1, wherein the skin layer has a basis weight between about 1% and about 10% of the core layer basis weight.

10. The elastic laminate of claim 1, wherein the skin layer has a thickness between about 0.00002 and about 0.008 millimeters.

11. The elastic laminate of claim 1, wherein the skin layer comprises an elastic polyolefin-based polymer having a degree of crystallinity between about 3% and about 40%.

12. The elastic laminate of claim 1, wherein the film layer comprises a second skin layer comprising a polymer and a diatomaceous earth.

13. The elastic laminate of claim 1, wherein the ultimate elongation of the film is between about 600 and about 800 percent.

14. The elastic laminate of claim 1, wherein the necked facing layer is thermally bonded to the first skin layer with a cross-direction oriented line pattern.

15. The elastic laminate of claim 1, wherein the necked facing layer is thermally bonded to the first skin layer with a bond pattern having a bond area density between about 5 and about 50 percent.

16. The elastic laminate of claim 1, wherein the necked facing layer is thermally bonded to the first skin layer with a bond pattern having an array of individual bond points, the individual bond points having a surface area of greater than about 0.5 square millimeters.

17. The elastic laminate of claim 1, wherein the laminate does not include any post-calender treatment.

18. The elastic laminate of claim 1, wherein the film has a basis weight up to about 80 gsm.

19. The elastic laminate of claim 1, wherein the film has a higher first cycle extension tension at 50% extension before the film is bonded to the necked facing layer than the elastic laminate.

20. The elastic laminate of claim 1, wherein the first skin layer is stretch thinned.

21. The elastic laminate of claim 15, wherein the first skin layer has apertures formed adjacent the thermal bond points.

22. A personal care product comprising the elastic laminate of claim 1.

23. An elastic single-faced neck bonded laminate comprising:
an external elastic layer comprising a film, the film comprising a core layer and first and second skin layers, the core layer comprising a styrene-isoprene-styrene block copolymer or a styrene-butadiene-styrene block copolymer, the first skin layer comprising a polymer having a softening point between about 40° C. about 125° C.; and
a necked facing layer thermally bonded to the first skin layer with a cross-direction oriented line pattern having an array of individual bond points, the individual bond points having a surface area of between about 0.1 and about 2 square millimeters, the line pattern having a bond area density between about 0.0001 and about 10 percent.

24. An elastic single-faced neck bonded laminate comprising:
an external elastic layer comprising a film, the film comprising a core layer and first and second skin layers; and
a necked facing layer thermally bonded to the first skin layer;
wherein the film has a higher first cycle extension tension at 50% extension before the film is bonded to the necked facing layer than the elastic laminate.
